(19) United States
(12) Patent Application Publication
(10) Pub. No.: US 2026/0049963 A1
(43) Pub. Date: Feb. 19, 2026

(54) APPARATUS AND METHOD WITH QUARTZ CRYSTAL MICROBALANCE AND FLOW CELL

(71) Applicant: LAM RESEARCH AG, Villach (AT)

(72) Inventors: Michael KLEMM, Villach (AT); Daniel BRIEN, Villach (AT)

(21) Appl. No.: 19/103,896

(22) PCT Filed: Aug. 14, 2023
(86) PCT No.: PCT/EP2023/072372

§ 371 Date: Feb. 14, 2025

(30) Foreign Application Priority Data
Aug. 22, 2022 (GB) 221291.7

(51) Int. Cl. G01N 29/02; G01N 29/036; G01N 29/22

(52) U.S. Cl. CPC G01N 29/022; G01N 29/036; G01N 29/222

(57) ABSTRACT

An apparatus comprising: a quartz crystal microbalance comprising a quartz crystal resonator having a coating; and a flow cell arranged to flow a liquid over the coating.

### FIELD OF THE INVENTION

The present invention relates to an apparatus and a method, and in particular, but not exclusively, to an apparatus and a method for monitoring etching of a material using a quartz crystal microbalance.

### BACKGROUND

In semiconductor device fabrication, a plurality of different processes are typically performed on a semiconductor wafer to fabricate a semiconductor device on the semiconductor wafer. These processes typically include etching a layer of material that has previously been deposited on the surface of the semiconductor wafer to remove some of the material. This is typically achieved by dispensing an etching chemical onto the surface of the semiconductor wafer to etch the layer of material on the surface of the semiconductor wafer.

To etch a predetermined amount of the material, a predetermined etching chemical (for example having a predetermined concentration and/or a predetermined pH value) may be dispensed onto the surface of the semiconductor wafer for a predetermined amount of time. However, the rate of etching of the material may be significantly influenced by the properties of the etching chemical, and small changes in the properties of the etching chemical (for example the concentration and/or pH value) may cause significant variation in the amount of etching that occurs in the predetermined amount of time.

A single etching cycle performed on a layer of material on the surface of a semiconductor wafer to etch the material may remove of the order of 10 nm (100 Å) of thickness of the layer of material. Therefore, a high sensitivity is required to monitor the etching, even when multiple etching cycles are performed.

It is known to detect an amount of etching of a layer of material on the surface of a semiconductor wafer using an external metrology tool, for example by using a high precision microbalance to measure a change in the mass of the semiconductor wafer caused by the etching, or by using ellipsometry to detect a reduction in the thickness of the material caused by the etching. However, such techniques require the semiconductor wafer to be transported to the external metrology tool and may therefore require a significant amount of time, which may delay the semiconductor device fabrication. In addition, such techniques are not able to monitor the amount of etching in situ and instead require the provision of the additional external metrology tool.

It is also known to indirectly estimate an amount of etching of a layer of material on the surface of a semiconductor wafer by measuring a concentration and/or a pH value of an etching chemical that is being (or will be) dispensed onto the surface of the semiconductor wafer. However, these techniques do not directly measure an amount of etching of the layer of material by the etching chemical. In addition, these techniques may also require complex or expensive devices for performing the measurements, particularly when dealing with an etching chemical that consists of several different constituents, or where bath loading/aging can play a role. Bath loading/aging refers to the build-up of material of the etched layer of material as a contaminant in the etching chemical when the etching chemical is reclaimed and reused after being used to etch the layer of material. The presence of such a contaminant in the etching chemical can reduce the etch rate of the etching chemical, for example by reducing a concentration and/or a pH value of the etching chemical.

Therefore, there is a need for an improved technique for monitoring etching of a layer of material, for example a technique that can be used in-situ and/or without requiring the provision of an additional external metrology tool.

A quartz crystal microbalance is a device that can be used to measure a change in mass per unit area at a surface of a quartz crystal resonator, by measuring a change in a resonant frequency of the quartz crystal resonator caused by the change in the mass per unit area at the surface of the quartz crystal resonator.

A quartz crystal microbalance can measure the change in the mass per unit area at the surface of the quartz crystal resonator with high sensitivity, for example of the order of 1 ng/cm². Depending on the density of the material, this sensitivity may allow changes in the thickness of the material of the order of 0.01 nm (0.1 Å) to be detected, for example.

A quartz crystal microbalance operates based on the piezoelectric effect, in which the application of an electric field to a quartz crystal produces mechanical deformation of the quartz crystal. By applying an oscillating electric field with an appropriate frequency to the quartz crystal, the quartz crystal can be caused to oscillate with a specific resonant frequency. This resonant frequency may be a fundamental resonant frequency, or a higher order resonant frequency.

The specific resonant frequency of the quartz crystal depends on the mass per unit area at the surface of the quartz crystal. Therefore, a change in the mass per unit area at the surface of the quartz crystal will cause a shift in the resonant frequency of the quartz crystal. Therefore, by measuring the shift in the resonant frequency of the quartz crystal, the change in the mass per unit area at the surface of the quartz crystal can be calculated.

For example, the change in the mass per unit area at the surface of a quartz crystal may be calculated from the shift in the resonant frequency of the quartz crystal using the following equation:

$$Δ m = - C \cdot Δ f$$

where Δm is the change in the mass per unit area at the surface of the quartz crystal (in g/cm² for example), Δf is the shift in the fundamental resonant frequency of the quartz crystal (in Hz) and C is a constant that depends on the properties of the quartz crystal used (in g/(cm²·Hz) for example). This equation corresponds to the Sauerbrey equation, which is well known in this technical field and therefore is not described here in detail.

FIG. 1 is a simplified schematic illustration of a quartz crystal resonator 1 for use in a quartz crystal microbalance. As shown in FIG. 1, the quartz crystal resonator 1 comprises a quartz crystal wafer 3. The quartz crystal wafer 3 may be cut from a bulk quartz crystal at an appropriate specific orientation with respect to the crystallographic axis of the bulk quartz crystal. For example, the quartz crystal wafer 3 may be an AT cut quartz crystal wafer. In addition, the quartz crystal resonator 1 comprises a first electrode 5 provided on a first main surface (e.g. a top surface) of the quartz crystal wafer 3 and a second electrode 7 provided on an opposite second main surface (e.g. a bottom surface) of the quartz crystal wafer 3. The quartz crystal wafer 3 is therefore sandwiched between the first and second electrodes 5 and 7.

The electrodes may comprise, or be made of, gold, for example.

Typically, the first and/or second electrode 5 and 7 is provided on only part of the first and/or second main surface of the quartz crystal wafer 3, so that part of the first and/or second main surface of the quartz crystal wafer 3 is exposed.

In FIG. 1 an alternating current and/or voltage source 9 is electrically connected to the quartz crystal resonator 1. Specifically, the alternating current and/or voltage source 9 is connected to the first and second electrodes 5 and 7 of the quartz crystal resonator 1 and is configured to apply an alternating current and/or voltage to the first and second electrodes 5 and 7. By applying an alternating current and/or voltage with an appropriate frequency to the first and second electrodes 5 and 7, the quartz crystal wafer 3 can be caused to oscillate at a resonant frequency of the quartz crystal wafer 3, for example a fundamental resonant frequency. This resonant frequency of the quartz crystal wafer 3 can be detected in a conventional manner, and changes in the resonant frequency caused by changes in the mass per unit area at the surface of a quartz crystal wafer 3 can therefore be detected. This is the general principle on which a quartz crystal microbalance operates.

FIG. 2 is a simplified schematic illustration of a quartz crystal microbalance 2. The quartz crystal microbalance 2 comprises the quartz crystal resonator 1 of FIG. 1. Specifically, the quartz crystal resonator 1 comprises the quartz crystal wafer 3 sandwiched between the first and second electrodes 5 and 7 as illustrated in FIG. 1 and as described above. In practice, the quartz crystal microbalance 2 typically comprises a holder in which the quartz crystal resonator 1 is held with at least one main surface (e.g. a top surface) of the quartz crystal resonator 1 exposed.

As shown in FIG. 2, the quartz crystal microbalance 2 further comprises a controller 4 and crystal oscillator electronics 6. The crystal oscillator electronics 6 is electrically connected to the quartz crystal resonator 1 and is configured to drive oscillation of the quartz crystal resonator 1, for example by applying an alternating current and/or voltage to the first and second electrodes 5 and 7 of the quartz crystal resonator 1. The controller 4 is electrically connected to the crystal oscillator electronics 6 and is configured to control the operation of the crystal oscillator electronics 6 to drive oscillation of the quartz crystal resonator 1, and to detect a resonant frequency of the quartz crystal resonator 1, for example a fundamental resonant frequency of the quartz crystal resonator 1.

Of course, the quartz crystal microbalance 2 may include additional components to those illustrated in FIG. 2.

FIG. 3 is a simplified schematic illustration of an oscillator circuit for detecting a resonant frequency of a quartz crystal resonator 1 that may be used in the quartz crystal microbalance 2. As shown in FIG. 3, the quartz crystal resonator 1 is placed in an oscillator circuit in which the quartz crystal resonator 1 is driven to oscillate by an automatic gain control amplifier 8. The quartz crystal resonator 1 is terminated into a load resistor 10 that is connected to ground. By returning the voltage on the load resistor 10 to the input of the automatic gain control amplifier 8, the oscillator circuit will oscillate at a frequency for which the phase shift around the loop is 0°, or an integer multiple of 360°, provided there is sufficient gain. This phase condition may be satisfied at resonance of the quartz crystal resonator 1. Therefore, the resonant frequency of the quartz crystal resonator 1 can be detected by determining the frequency of oscillation of the oscillator circuit in FIG. 3.

Of course, a different type of circuit or detector may be used for detecting the resonant frequency of the quartz crystal resonator to the oscillator circuit illustrated in FIG. 3.

Various different types of quartz crystal microbalances are commercially available, and their operation is well understood and described in the literature. Their operation is therefore not described further here.

Quartz crystal microbalances have previously been used to monitor deposition or adsorption of material at the surface of the quartz crystal, for example to monitor gas phase film deposition, or molecular adsorption at the crystal interface in liquids, or self-assembled monolayer (SAM) coverage on the crystal interface in liquids.

The present invention has been devised in light of the above considerations.

### SUMMARY OF THE INVENTION

The present invention may solve one or more of the problems identified above.

At its most general, the present invention relates to using a quartz crystal microbalance to monitor or investigate etching of a coating formed on a quartz crystal resonator of the quartz crystal microbalance.

As discussed above, a quartz crystal microbalance can be used to measure the change in the mass per unit area at the surface of a quartz crystal resonator with high sensitivity, for example of the order of 1 ng/cm². Depending on the density of the material of the coating, this sensitivity may allow changes in the thickness of the coating of the order of 0.01 nm (0.1 Å) to be detected, for example.

A single etching cycle performed on a layer of material to etch the material may remove of the order of 10 nm (100 Å) of thickness of the layer of material, or as low as 1 nm (10 Å) of thickness of the layer of material. Therefore, a quartz crystal microbalance may provide a sufficiently high sensitivity for monitoring the etching. In addition, a quartz crystal microbalance may be used to provide in-situ or in-line monitoring of the etching.

According to a first aspect of the present invention there is provided an apparatus comprising: a quartz crystal microbalance comprising a quartz crystal resonator having a coating; and a flow cell arranged to flow a liquid over the coating.

The first aspect of the present invention may have any one, or, where compatible, any combination of the following optional features.

The quartz crystal microbalance may have any of the features of the quartz crystal microbalance discussed above and/or illustrated in FIGS. 1 to 3, for example.

The quartz crystal microbalance comprises a quartz crystal resonator.

The quartz crystal resonator may comprise a quartz crystal or a quartz crystal wafer.

The quartz crystal resonator may be a quartz crystal oscillator.

The quartz crystal resonator (and/or the quartz crystal or quartz crystal wafer) may be disc shaped, or wafer shaped.

The quartz crystal resonator (and/or the quartz crystal or quartz crystal wafer) may have a diameter of 25 mm, or a diameter of more than, or equal to, 20 mm and less than, or equal to, 30 mm, for example.

The quartz crystal resonator (and/or the quartz crystal or quartz crystal wafer) may have opposite first and second main surfaces or main faces.

The quartz crystal resonator may comprise a quartz crystal or quartz crystal wafer that is cut from a bulk quartz crystal at an appropriate specific orientation with respect to the crystallographic axis of the bulk quartz crystal. For example, the quartz crystal or quartz crystal wafer may be an AT cut quartz crystal or quartz crystal wafer.

The quartz crystal or quartz crystal wafer may be sandwiched between a pair of electrodes.

The quartz crystal resonator may comprise a pair of electrodes sandwiching the quartz crystal or quartz crystal wafer.

The quartz crystal resonator may comprise a first electrode provided on a first main face or main surface of the quartz crystal or quartz crystal wafer and a second electrode provided on an opposite second main face or main surface of the quartz crystal or quartz crystal wafer.

The quartz crystal microbalance may comprise an alternating current and/or voltage source electrically connected to the electrodes and configured to apply an alternating current and/or voltage to the electrodes.

The electrodes may comprise, or be made of, gold, for example.

The first electrode may be provided on only part of the first main face or main surface of the quartz crystal or quartz crystal wafer, so that part of the first main face or main surface of the quartz crystal or quartz crystal wafer is exposed.

The second electrode may be provided on only part of the second main face or main surface of the quartz crystal or quartz crystal wafer, so that part of the second main face or main surface of the quartz crystal or quartz crystal wafer is exposed.

The quartz crystal microbalance may comprise crystal oscillator electronics for driving oscillation of the quartz crystal resonator. For example, the crystal oscillator electronics may be configured to apply an alternating current and/or voltage to the quartz crystal resonator, for example to the first and second electrodes of the quartz crystal resonator.

The quartz crystal microbalance may comprise a controller for controlling an operation of the quartz crystal microbalance. For example, the controller may be configured to control the crystal oscillator electronics to drive oscillation of the quartz crystal resonator, and to detect a resonant frequency of the quartz crystal resonator.

The quartz crystal microbalance may comprise an oscillator circuit for detecting a resonant frequency of the quartz crystal resonator.

The quartz crystal resonator may have a fundamental resonant frequency of the order of 5 MHz.

A coating may mean a layer of material provided on a surface of the quartz crystal resonator, for example on a surface of a quartz crystal or quartz crystal wafer of the quartz crystal resonator.

The coating may be a film.

The coating may be provided on a main surface or main face of the quartz crystal resonator (or quartz crystal or quartz crystal wafer).

The coating may be provided only on the main surface or main face of the quartz crystal resonator (or quartz crystal or quartz crystal wafer).

The coating may be provided only on part of a surface of the quartz crystal resonator (or quartz crystal or quartz crystal wafer).

The coating may be provided only on part of the quartz crystal resonator (or quartz crystal or quartz crystal wafer).

The coating may be a layer of material deposited on a surface of the quartz crystal resonator (or quartz crystal or quartz crystal wafer).

The quartz crystal or quartz crystal wafer may have a main surface (for example a top surface), part of which is covered by the first or second electrode and part of which is covered by the coating.

The first electrode may be formed on the top surface (main surface) of the quartz crystal wafer so as to cover only part of the top surface of the quartz crystal wafer, and the coating may be formed on another part of the top surface of the quartz crystal wafer so as to cover another part of the top surface of the quartz crystal wafer. In other words, the first electrode and the coating may be provided on different parts of the top surface of the quartz crystal wafer.

The coating may be made from only a single material. Alternatively, the coating may comprise a plurality of different materials.

The coating may be deposited on the quartz crystal resonator by PVD, for example, but other types of deposition or coating techniques are known and could be used instead, for example CVD or ALD.

A mass per unit area of the coating affects a resonant frequency of oscillation of the quartz crystal resonator. In other words, a resonant frequency of the quartz crystal resonator depends on a mass per unit area of the coating, such that a change in the mass per unit area of the coating causes a shift in the resonant frequency of the quartz crystal resonator. The quartz crystal microbalance can therefore be used to monitor a mass per unit area of the coating on the quartz crystal resonator.

A decrease in the mass per unit area of the quartz crystal resonator may cause an increase in the resonant frequency of the quartz crystal resonator.

The flow cell may be configured and/or adapted to flow the liquid over the coating.

A flow cell may mean any flow path, or flow chamber, or passageway, or tube, that is arranged to flow the liquid over the coating.

The flow cell is arranged to bring the liquid into contact with the coating.

The flow cell may comprise a flow path, or flow chamber, that brings the liquid into contact with the coating and flows the liquid over the coating.

Flowing the liquid over the coating may mean moving or passing the liquid over the coating.

The flow cell may be configured to bring the liquid into contact with some, most or all of the coating.

The flow cell may comprise an inlet for connecting the flow cell to a supply of the liquid so that the liquid can enter the flow cell via the inlet.

The flow cell may comprise an outlet for connecting the flow cell to a flow path so that the liquid can exit the flow cell via the outlet.

The flow cell may be connected in a recirculation loop, so that the liquid is recirculated between the supply of the liquid and the flow cell.

The flow cell may comprise a flow path, or flow chamber, that connects the inlet to the outlet, or that is connected to the inlet and outlet, and that brings the liquid into contact with the coating and flows the liquid over the coating.

A volume of the flow path or flow chamber (for example from an inlet of the flow path or flow chamber to an outlet of the flow path or flow chamber) may be less than or equal 10 mL. The volume may be greater than or equal to 0.1 mL. The volume may be greater than or equal to 0.1 mL and less than or equal to 10 mL. In a specific embodiment the volume may be greater than or equal to 1 mL and less than or equal to 2 mL, for example greater than or equal to 1.0 mL and less than or equal to 2.0 mL, for example approximately 1 mL.

A volume of a region of the flow path or flow chamber that is opposite (for example directly opposite) to an area of the quartz crystal resonator that is in contact with the liquid may be less than or equal to 2 mL, for example less than or equal to 2.0 mL. The volume may be greater than or equal to 0.05 mL. The volume may be greater than or equal to 0.05 mL and less than or equal to 2 mL or 2.0 mL, for example approximately 0.15 mL.

A volume of a region of the flow path or flow chamber defined by an area of the quartz crystal resonator that is in contact with the liquid multiplied by a distance between the quartz crystal resonator and an opposing surface of the flow path or flow chamber may be less than or equal to 2 mL, for example less than or equal to 2.0 mL. The volume may be greater than or equal to 0.05 mL. The volume may be greater than or equal to 0.05 mL and less than or equal to 2 mL or 2.0 mL, for example approximately 0.15 mL.

The distance between the area of the quartz crystal resonator in contact with the liquid and the opposing surface of the flow path or flow chamber may be greater than or equal to 0.2 mm and less than or equal to 5 mm, for example approximately 2 mm.

The area of the quartz crystal resonator in contact with the liquid may be greater than or equal to 0.1 cm² and less than or equal to 10 cm², for example approximately 0.5 cm².

The flow cell may comprise, or be made of, a chemically inert material.

The flow cell may comprise, or be made of, polytetrafluoroethylene (PTFE).

The quartz crystal resonator is arranged in, or relative to, the flow cell so that the coating on the quartz crystal resonator (or quartz crystal or quartz crystal wafer) is brought into contact with the liquid flowing in the flow cell.

The quartz crystal resonator may be received in, or received by, the flow cell, or at least partially received in, or received by, the flow cell.

The flow cell may have an opening or a window in which the quartz crystal resonator is (at least partially) positioned or received so that the coating on the quartz crystal resonator is brought into contact with the liquid flowing in the flow cell.

The flow cell may house the quartz crystal resonator so that the coating on the quartz crystal resonator is brought into contact with the liquid flowing in the flow cell. For example, the flow cell may comprise a space or cavity in which the quartz crystal resonator is housed.

Preferably, the quartz crystal resonator is removable from the flow cell. For example, the flow cell may be openable to remove the quartz crystal resonator from a space or cavity in the flow cell, or the quartz crystal resonator may be removable from a window or opening in the flow cell.

The flow cell may be configured to provide or enable symmetric liquid flow in the flow cell over the coating. This may prevent or reduce non-uniform etching of the coating.

The apparatus may comprise a temperature control mechanism for controlling a temperature of the flow cell. For example, the temperature control mechanism may be configured to maintain a constant temperature of the flow cell to within ±0.5° C., or within ±0.1° C.

The apparatus may comprise a heater and/or a cooler for controlling a temperature of the flow cell. For example, the heater and/or cooler may be configured to maintain a constant temperature of the flow cell to within ±0.5° C., or within ±0.1° C.

The apparatus may comprise a temperature control mechanism for controlling a temperature of the liquid in the flow cell. For example, the temperature control mechanism may be configured to maintain a constant temperature of the liquid in the flow cell to within ±0.5° C., or within ±0.1° C.

The apparatus may comprise a heater and/or a cooler for controlling a temperature of the liquid in the flow cell. For example, the heater and/or cooler may be configured to maintain a constant temperature of the liquid in the flow cell to within ±0.5° C., or within ±0.1° C.

The apparatus may comprise a temperature control mechanism for controlling a temperature of the quartz crystal resonator. For example, the temperature control mechanism may be configured to maintain a constant temperature of the quartz crystal resonator to within ±0.5° C., or within ±0.1° C.

The apparatus may comprise a heater and/or a cooler for controlling a temperature of the quartz crystal resonator. For example, the heater and/or cooler may be configured to maintain a constant temperature of the quartz crystal resonator to within ±0.5° C., or within ±0.1° C.

Of course, a single temperature control mechanism, or a single heater and/or cooler, may be configured to provide one or more of the temperature controlling functions described above.

The coating may comprise one or more of SiO₂, or Al₂O₃, or TiN, or Cu, or W, or Si, or Si₃N₄, or TaN, or Co, or SiOₓ, or W doped C, or Co, or SnOₓ, or C (polymer, or amorphous, or diamond like, for example), or SiCₓNᵥ. Such materials are typically etched during manufacture of semiconductor devices.

The coating may have a thickness greater than, or equal, to 0.5 μm. Assuming a typical etching cycle removes approximately 10 nm (100 Å) of the coating, this means that a 0.5 μm thickness coating could be used to monitor approximately 50 etching cycles. If the etching cycle removes less material, for example 1 nm (10 Å) of the coating, the coating may be used to monitor more etching cycles, for example 500 etching cycles. The quartz crystal resonator may then have a longer lifespan.

The coating may have a thickness that is: greater than, or equal to, 0.01 μm; and/or greater than, or equal to, 0.1 μm; and/or greater than, or equal, to, 0.5 μm; and/or greater than, or equal to, 1 μm; and/or less than, or equal to, 5 μm; and/or less than, or equal to, 10 μm.

The coating may have a thickness that is greater than, or equal to, 0.01 μm and less than, or equal to, 5 μm or 10 μm.

A thickness as low as 0.01 μm may be used for detecting whether or not etching has occurred, for example.

The coating may have a thickness that is greater than, or equal to, 0.1 μm and less than, or equal to, 5 μm or 10 μm.

The coating may have a thickness that is greater than, or equal to 1 μm and less than, or equal to, 5 or 10 μm.

The apparatus may be configured to detect a resonant frequency of the quartz crystal resonator, for example a fundamental resonant frequency. The resonant frequency is a resonant frequency of oscillation of the quartz crystal resonator.

The quartz crystal microbalance may be configured to detect a resonant frequency of the quartz crystal resonator, for example a fundamental resonant frequency.

The apparatus or quartz crystal microbalance may comprise a detector that is configured to detect a resonant frequency of the quartz crystal resonator, for example a fundamental resonant frequency.

The quartz crystal microbalance may comprise an oscillator circuit for detecting a resonant frequency of the quartz crystal resonator. For example, the oscillator circuit may be as illustrated in FIG. 3 and described above.

The apparatus or quartz crystal microbalance may be configured to determine a shift in a resonant frequency of the quartz crystal resonator, for example a fundamental resonant frequency. For example, the apparatus or quartz crystal microbalance may comprise a controller or processor that is configured to determine a shift in a resonant frequency of the quartz crystal resonator. For example, the controller or processor may be configured to determine or calculate a shift in the resonant frequency of the quartz crystal resonator based on the resonant frequency of the quartz crystal resonator detected or determined at two different times (for example before and after an etching liquid or chemical has been flowed over the coating).

A shift in the resonant frequency of the quartz crystal resonator means a change in the resonant frequency of the quartz crystal resonator.

The apparatus or quartz crystal microbalance may be configured to determine information indicative of an amount of etching of the coating by the liquid from the shift in the resonant frequency of the quartz crystal resonator. For example, the apparatus or quartz crystal microbalance may comprise a controller or processor that is configured to determine information indicative of an amount of etching of the coating by the liquid from the shift in the resonant frequency of the quartz crystal resonator.

As discussed above, a resonant frequency of the quartz crystal resonator depends on the mass per unit area of the coating on the quartz crystal resonator. Therefore, when the coating on the quartz crystal resonator is etched, such that the mass per unit area of the coating is reduced, there will be a shift in the resonant frequency of the quartz crystal resonator.

The apparatus or quartz crystal microbalance (for example a controller of the apparatus or quartz crystal microbalance) may be configured to determine an amount of etching of the coating by the liquid from the shift in the resonant frequency of the quartz crystal resonator.

The apparatus or quartz crystal microbalance may be configured to monitor etching of the coating by the liquid based on, or from, the shift in the resonant frequency of the quartz crystal resonator. For example, the apparatus or quartz crystal microbalance may comprise a controller or processor that is configured to monitor etching of the coating by the liquid based on, or from, the shift in the resonant frequency of the quartz crystal resonator.

The apparatus or quartz crystal microbalance (for example a controller or processor of the apparatus or quartz crystal microbalance) may be configured to determine, based on the shift in the resonant frequency of the quartz crystal resonator: an etch rate of the coating; or a decrease in the mass per unit area of the coating; or a decrease in the mass of the coating; or a decrease in the thickness of the coating.

The apparatus or quartz crystal microbalance may be configured to detect whether or not etching of the coating has occurred based on the resonant frequency of the quartz crystal resonator. For example, the apparatus or quartz crystal microbalance may be configured to determine that etching has not occurred when there is no shift in the resonant frequency of the quartz crystal resonator.

The apparatus may comprise a liquid source connected to the flow cell and configured to supply a liquid to the flow cell. The liquid source may contain and/or store and/or hold the liquid.

The liquid source may comprise liquid contained and/or stored and/or held in the liquid source.

The liquid may be, or comprise, an etching liquid or etching chemical.

The liquid may be configured to etch the coating.

The liquid may be configured to etch a material of the coating.

The liquid source may be or comprise a tank or container.

The apparatus may comprise: a first liquid source connected to the flow cell for supplying a first liquid to the flow cell; a second liquid source connected to the flow cell for supplying a second liquid to the flow cell; and one or more valves for controlling supply of the first liquid to the flow cell and supply of the second liquid to the flow cell.

The apparatus may comprise a controller that is configured to control operation of the one or more valves to supply either the first liquid or the second liquid to the flow cell.

The first liquid may be a cleaning or rinse liquid, such as deionised water.

The second liquid may be configured to etch the coating, or a material of the coating.

The second liquid may be an etching liquid or etching chemical, such as hydrofluoric acid. Of course, other etching chemicals may be used instead, such as H₂O₂, for example.

The etching liquid or chemical may be deionised.

The cleaning or rinse liquid may be deionised.

The first liquid source may contain and/or store and/or hold the first liquid.

The second liquid source may contain and/or store and/or hold the second liquid.

The first liquid source and/or the second liquid source may be or comprise a tank or container.

The apparatus (for example a controller or processor of the apparatus) may be configured to control the one or more valves to firstly supply the first liquid (for example a cleaning or rinse liquid) to the flow cell for a predetermined period of time, then to subsequently supply the second liquid (for example an etching liquid or etching chemical) to the flow cell for a predetermined period of time, and then to subsequently supply the first liquid to the flow cell for a predetermined period of time.

Alternatively, the apparatus may comprise a third fluid source connected to the flow cell for supplying a third liquid to the flow cell, and the one or more valves may control supply of the third liquid to the flow cell for the predetermined period of time after the supply of the second liquid. For example, the third liquid may be a rinse liquid, which may be a different rinse liquid to the first liquid.

The apparatus, or quartz crystal microbalance, may comprise a holder that holds, or that is configured to hold, the quartz crystal resonator.

The holder may hold the quartz crystal resonator with the coating of the quartz crystal resonator exposed and/or accessible.

The first aspect of the present invention may alternatively be referred to as a device or a system instead of an apparatus.

An application or use of the apparatus of the first aspect of the present invention may be to monitor or investigate etching of a material on a surface of a wafer during processing of the wafer, for example during semiconductor device fabrication.

An application or use of the apparatus according to the first aspect of the present invention may be to determine an etching amount or an etching rate of an etching liquid that will subsequently be used to etch a material on a surface of a wafer during processing of the wafer, for example during semiconductor device fabrication.

According to a second aspect of the present invention there is provided a wafer processing apparatus comprising: a liquid dispenser for dispensing a liquid onto a surface of a wafer; a liquid supply for supplying a liquid from a liquid source to the liquid dispenser; and the apparatus according to the first aspect of the present invention, wherein the flow cell is connected to the liquid source or the liquid supply.

Therefore, the same liquid that is dispensed onto the surface of the wafer can also be supplied to the flow cell of the apparatus according to the first aspect of the present invention. Therefore, if a material of the coating is the same as a material of the surface of the wafer, and the liquid is an etching liquid that is configured to etch the material, an amount of etching or an etching rate of the coating may be the same as, or related to, or correspond to, an amount of etching or an etching rate of the material of the surface of the wafer.

Therefore, by monitoring the etching of the coating it may be possible to indirectly monitor the etching of the material on the surface of the wafer, and/or to predict the etching of the material on the surface of the wafer.

The second aspect of the present invention may have any one, or, where compatible, any combination of the following optional features.

The second aspect of the present invention may have any of the features of the first aspect of the present invention, unless incompatible.

A wafer processing apparatus may mean any apparatus that is configured to process a wafer.

The wafer processing apparatus may be configured to etch a material on a surface of the wafer by dispensing an etching liquid or etching chemical onto the surface of the wafer.

The liquid dispenser may comprise a nozzle for dispensing the liquid onto the surface of the wafer.

The nozzle may be positioned or located or provided on an arm of the wafer processing apparatus.

The arm may be pivotably mounted so that a position of the nozzle relative to the wafer can be changed.

The wafer processing apparatus may comprise a support or chuck for supporting or holding the wafer.

The support or chuck may be rotatable.

Typically the support or chuck supports the wafer from beneath while the liquid is dispensed onto the wafer from above, i.e. onto a top surface of the wafer.

A liquid source may be a container or tank that holds a volume of the liquid. Alternatively, the liquid source may be a flow path, tube or passageway that supplies the liquid to the liquid supply of the wafer processing apparatus.

The liquid source may be external to the wafer processing apparatus, and therefore not part of the wafer processing apparatus. Alternatively, the wafer processing apparatus may comprise the liquid source.

The liquid supply may comprise one or more flow paths, tubes or passageways for supplying the liquid to the liquid dispenser.

There may be a plurality of different liquid sources for supplying different liquids to the liquid dispenser, for example a cleaning or rinse liquid and an etching liquid.

A single liquid supply may be connected to each of the plurality of different liquid sources for supplying the different liquids to the liquid dispenser. Alternatively, there may be a plurality of liquid supplies for supplying the liquids from the liquid sources to the liquid dispenser.

There may be more than one liquid dispenser. For example, a different liquid dispenser may be used for each different liquid supplied from each liquid source.

Where there is more than one liquid supply and/or liquid source, the flow cell may be connected to each of the liquid sources and/or liquid supplies.

The flow cell being connected to the liquid source or the liquid supply means that the liquid can be supplied to the flow cell, so that the liquid is flowed over the coating. The connection is therefore a fluid connection or liquid connection.

The flow cell may be connected to the liquid source via a recirculation loop between the liquid source and the flow cell.

The apparatus may comprise a valve for controlling supply of the liquid to the flow cell.

For example, the liquid source may be a tank or container of the liquid, and the flow cell may be connected to the tank or container via a recirculation loop between the tank or container and the flow cell.

The flow cell may be connected to the liquid supply in series with the liquid dispenser, or in parallel with the liquid dispenser.

Liquid exiting the flow cell may be reclaimed and/or reused and/or recirculated, for example by being returned to the liquid source and/or the liquid supply. For example, the apparatus may comprise a reclaim line connecting an output of the flow cell to the liquid source and/or liquid supply. Alternatively, liquid exiting the flow cell may be collected or disposed of.

The wafer processing apparatus (for example a controller of the apparatus) may be configured to: dispense the liquid onto the surface of the wafer from the liquid dispenser; and simultaneously supply the liquid to the flow cell.

Therefore, while the liquid is being dispensed onto the surface of the wafer the liquid is also supplied to the flow cell and flowed over the coating. An amount of etching of the coating may therefore be the same as, or related to, or correspond to, an amount of etching of the material of the surface of the wafer.

For example, the wafer processing apparatus may comprise one or more valves for controlling dispensing of the liquid onto the surface of the wafer and for supplying the liquid to the flow cell. The wafer processing apparatus may further comprise a controller or processor for controlling operation of the one or more valves so as to control dispensing of the liquid onto the surface of the wafer and supplying the liquid to the flow cell.

Alternatively, the wafer processing apparatus (for example a controller of the apparatus) may be configured to supply the liquid to the flow cell independently of, or separately to, the dispensing of the liquid onto the surface of the wafer from the liquid dispenser.

The wafer processing apparatus (for example the quartz crystal microbalance) may be configured to determine, or calculate, or estimate, information indicative of an amount of etching of the coating from a shift in the resonant frequency of the quartz crystal resonator. For example, the information indicative of an amount of etching of the coating may be an etch rate of the coating or an amount of etching of the coating.

The wafer processing apparatus may be configured to control and/or modify subsequent dispensing of the liquid onto the surface of the wafer based on the information indicative of the amount of etching of the coating. For example, the wafer processing apparatus may control an amount of the liquid dispensed onto the surface of the wafer, or a duration during which the liquid is dispensed onto the surface of the wafer, based on the information indicative of the amount of etching of the coating.

For example, the wafer processing apparatus may be configured to determine an etch rate of the coating by the liquid. The wafer processing apparatus may then control and/or modify subsequent dispensing of the liquid onto the surface of the wafer based on the determined etch rate. For example, the wafer processing apparatus may control an amount of the liquid dispensed onto the surface of the wafer, or a duration during which the liquid is dispensed onto the surface of the wafer.

A material of the coating may be the same as a material of the surface of the wafer.

The surface of the wafer may have a coating or layer of the same material as the coating of the quartz crystal resonator.

The liquid may be an etching liquid or etching chemical that is configured to etch the material,

The term etching liquid or etching chemical may mean a liquid or chemical that is configured to etch the coating.

The wafer processing apparatus (for example a controller of the apparatus) may be configured to determine, or calculate, or estimate, information indicative of an amount of etching of a material of the surface of the wafer from a shift in the resonant frequency of the quartz crystal resonator.

The wafer processing apparatus (for example a controller of the apparatus) may be configured to monitor etching of a material of the surface of the wafer based on, or from, a shift in the resonant frequency of the quartz crystal resonator.

The wafer processing apparatus (for example a controller of the apparatus) may be configured to determine, or calculate, or estimate, based on the shift in the resonant frequency of the quartz crystal resonator: an etch rate of the material of the surface of the wafer; or a decrease in the mass per unit area of the material of the surface of the wafer; or a decrease in mass of the material of the surface of the wafer; or a decrease in thickness of the material of the surface of the wafer.

The wafer processing apparatus (for example a controller or processor of the wafer processing apparatus) may be configured to control an operation of the liquid dispenser based on a shift in the resonant frequency of the quartz crystal resonator.

The wafer processing apparatus (for example a controller or processor of the wafer processing apparatus) may be configured to control an operation of the wafer processing apparatus based on a shift in the resonant frequency of the quartz crystal resonator.

For example, when a desired or predetermined amount of etching of the coating is determined, the wafer processing apparatus may be configured to stop dispensing of the liquid by the liquid dispenser.

The wafer processing apparatus (for example a controller or processor of the wafer processing apparatus) may be configured to determine whether or not a desired or predetermined shift in the resonant frequency of the quartz crystal resonator has occurred and to stop dispensing of the liquid onto the surface of the wafer when it is determined that the desired or predetermined shift in the resonant frequency of the quartz crystal resonator has occurred.

According to a third aspect of the present invention there is provided a method comprising: flowing a liquid over a coating on a quartz crystal resonator of a quartz crystal microbalance using a flow cell.

The method according to the third aspect of the present invention may have any of the features of the first aspect and/or the second aspect of the present invention, unless incompatible.

The method according to the third aspect of the present invention may be performed using the apparatus according to the first aspect of the present invention or the wafer processing apparatus according to the second aspect of the present invention.

The third aspect of the present invention may have any one, or, where compatible, any combination of the following optional features.

The liquid may be configured to etch the coating.

The method may comprise detecting or determining whether or not the coating is etched by the liquid.

The method may comprise monitoring or investigating etching of the coating by the liquid.

The coating may comprise one or more of SiO₂, or Al₂O₃, or TiN, or Cu, or W, or Si, or Si₃N₄, or TaN, or Co, or SiOₓ, or W doped C, or Co, or SnOₓ, or C, or SiCₓNᵥ.

The liquid may comprise hydrofluoric acid. Of course, other etching chemicals may be used instead, such as H₂O₂, for example.

The liquid may comprise one or more of hydrofluoric acid, or H₂O₂, or HNO₃, or HNO₃ and HF, or DIO₃, or NH₄OH, or HCL.

The liquid may be deionised.

The method may comprise detecting a resonant frequency of the quartz crystal resonator, for example a resonant frequency such as the fundamental resonant frequency.

The method may comprise determining a shift or change in a resonant frequency of the quartz crystal resonator. The resonant frequency may be a resonant frequency such as a fundamental resonant frequency. In particular, as discussed above, etching of the coating by the liquid will reduce a mass per unit area of the coating and therefore cause a shift in the resonant frequency of the quartz crystal resonator. Therefore, by determining the shift or change in a resonant frequency of the quartz crystal resonator, the etching of the coating can be monitored.

The method may comprise determining information indicative of an amount of etching of the coating by the liquid from the shift in the resonant frequency of the quartz crystal resonator.

The method may comprise monitoring etching of the coating by the liquid based on, or from, the shift in the resonant frequency of the quartz crystal resonator.

The method may comprise determining or calculating, based on the shift in the resonant frequency of the quartz crystal resonator: an etch rate of the coating; or a decrease in the mass per unit area of the coating; or a decrease in mass of the coating; or a decrease in thickness of the coating.

The method may be a method of monitoring or controlling wafer etching, or wafer processing, or semiconductor device fabrication, for example.

The method may comprise dispensing the liquid onto a surface of the wafer, wherein the surface of the wafer comprises a same material as a material of the coating. For example, the wafer may comprise a layer or coating of the material on the surface of the wafer.

The method may comprise controlling and/or modifying the dispensing of the liquid onto the surface of the wafer based on a calculated etch rate of the coating, or decrease in the mass per unit area of the coating, or decrease in mass of the coating, or decrease in thickness of the coating. For example, the method may comprise controlling an amount of the liquid dispensed onto the surface of the wafer, or a duration during which the liquid is dispensed onto the surface of the wafer.

The method may comprise simultaneously dispensing the liquid onto a surface of a wafer, wherein the surface of the wafer comprises a same material as a material of the coating. For example, the wafer may comprise a layer or coating of the material on the surface of the wafer.

The method may comprises determining, or calculating, or estimating, information indicative of an amount of etching of the material of the surface of the wafer from a shift in the resonant frequency of the quartz crystal resonator. The resonant frequency may be a resonant frequency such as a fundamental resonant frequency.

The method may comprise determining, or calculating, or estimating, based on the shift in the resonant frequency of the quartz crystal resonator: an etch rate of the material of the surface of the wafer; or a decrease in the mass per unit area of the material of the surface of the wafer; or a decrease in mass of the material of the surface of the wafer; or a decrease in thickness of the material of the surface of the wafer.

The method may comprise controlling dispensing the liquid onto the surface of the wafer based on a shift in the resonant frequency of the quartz crystal resonator. The resonant frequency may be a resonant frequency, for example a fundamental resonant frequency. For example, the method may comprise determining whether or not a desired or predetermined shift in the resonant frequency of the quartz crystal resonator has occurred and stopping dispensing of the liquid onto the surface of the wafer when it is determined that the desired or predetermined shift in the resonant frequency of the quartz crystal resonator has occurred.

The method may comprise: flowing a cleaning or rinse liquid over the coating on the quartz crystal resonator; subsequently flowing a liquid that is configured to etch the coating over the coating on the quartz crystal resonator; and subsequently flowing a cleaning or rinse liquid over the coating on the quartz crystal resonator.

The method may comprise: detecting a first resonant frequency of the quartz crystal resonator while flowing the cleaning or rinse liquid over the coating on the quartz crystal resonator before the liquid that is configured to etch the coating; detecting a second resonant frequency of the quartz crystal resonator while flowing the cleaning or rinse liquid over the coating on the quartz crystal resonator after the liquid that is configured to etch the coating; and determining a shift in the resonant frequency of the quartz crystal resonator from the first resonant frequency and the second resonant frequency. The resonant frequency may be fundamental resonant frequency.

The method may comprise performing a first etching step in which the etching liquid is flowed over the coating so as to etch the coating, determining whether or not the resonant frequency of the quartz crystal resonator is greater than or equal to a predetermined resonant frequency, and if not performing a second etching step in which the etching liquid is flowed over the coating so as to etch the coating.

The method may comprise monitoring etching of the coating by the liquid, and subsequently controlling or modifying dispensing of the same liquid onto a surface of a wafer based on the results of the monitoring.

For example, the method may comprise determining an etch rate or amount of etching of the coating by the liquid, and subsequently controlling or modifying dispensing of the same liquid onto the surface of the wafer based on the determined etch rate or amount of etching of the coating.

The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIG. 1 is a simplified schematic illustration of a quartz crystal resonator for use in a quartz crystal microbalance.

FIG. 2 is a simplified schematic illustration of a quartz crystal microbalance.

FIG. 3 is a simplified schematic illustration of an oscillator circuit for detecting a resonant frequency of a quartz crystal resonator that may be used in the quartz crystal microbalance.

FIG. 4 is a schematic illustration of an apparatus according to an embodiment of the present invention.

FIG. 5 is a schematic illustration of an apparatus according to an embodiment of the present invention.

FIG. 6 is a schematic illustration of an apparatus according to an embodiment of the present invention.

FIG. 7 is a schematic illustration of a measurement result according to an embodiment of the present invention.

FIG. 8 is a schematic illustration of an apparatus according to an embodiment of the present invention.

FIG. 9 is a schematic illustration of an apparatus according to an embodiment of the present invention.

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

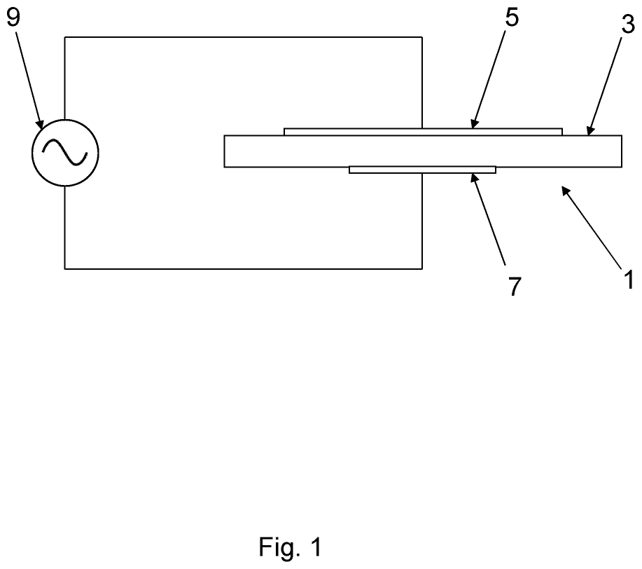

Embodiments of the present invention may include any of the features of FIGS. 1 to 3, for example as described above.

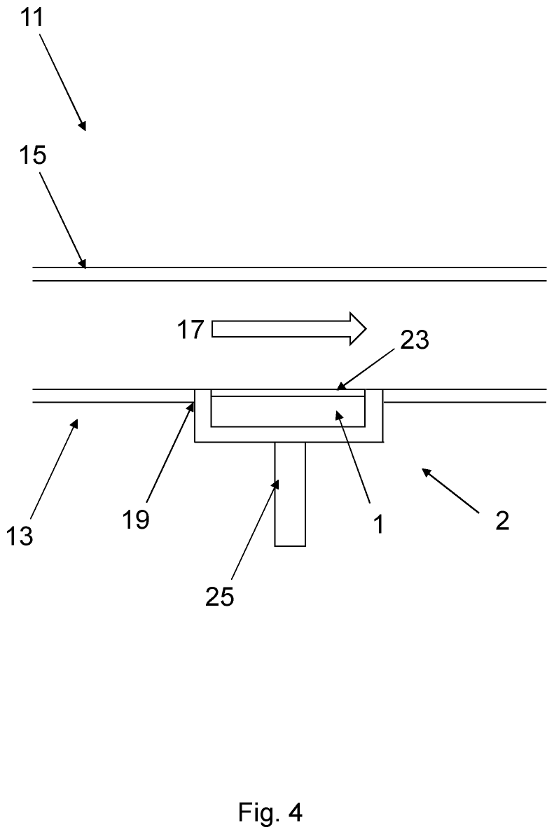

FIG. 4 is a schematic illustration of an apparatus according to an embodiment of the present invention. As illustrated in FIG. 4, the apparatus 11 comprises a flow cell 13. The flow cell 13 comprises a tube 15 or flow chamber along which a liquid can flow as indicated by the arrow 17. In addition, the flow cell 13 comprises an opening 19 or window in a side surface (for example a circumferential surface) of the tube 15.

The apparatus 11 further comprises a quartz crystal microbalance 2. The quartz crystal microbalance 2 may have any of the features of the quartz crystal microbalance 2 described above and/or illustrated in FIGS. 1 to 3, for example. Specifically, the quartz crystal microbalance 2 comprises a quartz crystal resonator 1, which may have any of the features of the quartz crystal resonator 1 described above and/or illustrated in FIGS. 1 to 3, for example. Specifically, the quartz crystal resonator 1 comprises a quartz crystal wafer 3, which may be cut from a bulk quartz crystal at an appropriate specific orientation with respect to the crystallographic axis of the bulk quartz crystal. For example, the quartz crystal wafer 3 may be an AT cut quartz crystal wafer. The quartz crystal wafer 3 is sandwiched between a pair of electrodes 5 and 7 as illustrated in FIG. 1. In particular, a first electrode 5 is provided on a first (e.g. top) surface of the quartz crystal wafer 3 and a second electrode 7 is provided on a second (e.g. bottom) surface of the quartz crystal wafer 3. The electrodes 5 and 7 are not illustrated in FIG. 4 for simplicity.

The electrodes 5 and 7 may comprise, or be made of, gold, for example.

The quartz crystal wafer 3 may be disc shaped, for example.

The quartz crystal wafer may have a thickness of between 100 μm and 500 μm, for example 330 μm.

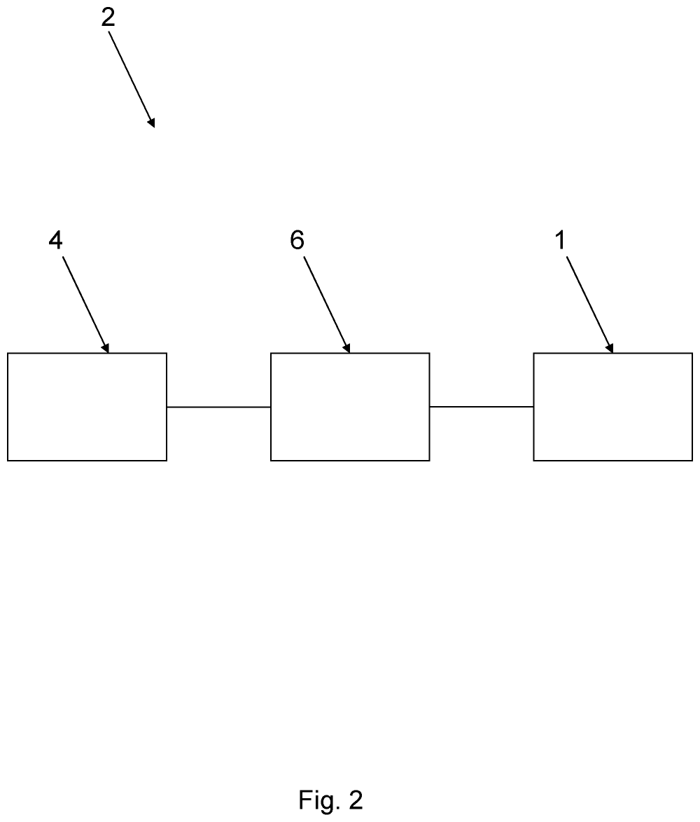

Although not illustrated in FIG. 4 for simplicity, the quartz crystal microbalance 2 further comprises a controller 4 and crystal oscillator electronics 6 as illustrated in FIG. 2. The crystal oscillator electronics 6 is electrically connected to the quartz crystal resonator 1 and is configured to drive oscillation of the quartz crystal resonator 1, for example by applying an alternating current and/or voltage to the first and second electrodes 5 and 7 of the quartz crystal resonator 1. The controller 4 is electrically connected to the crystal oscillator electronics 6 and is configured to control the operation of the crystal oscillator electronics 6 to drive oscillation of the quartz crystal resonator 1, and to detect a resonant frequency of the quartz crystal resonator 1, for example a fundamental resonant frequency of the quartz crystal resonator 1.

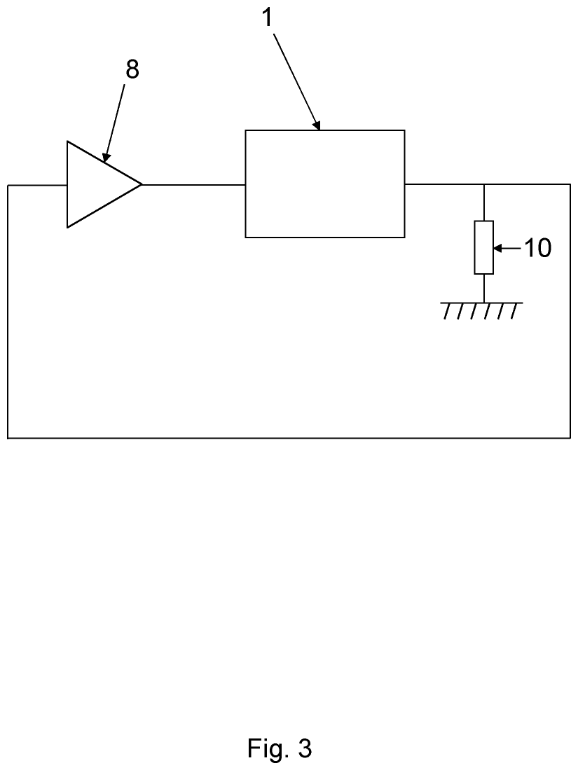

The quartz crystal microbalance 2 may further comprise the oscillator circuit illustrated in FIG. 3 and described above for detecting the resonant frequency of the quartz crystal resonator 1. Of course, other types of oscillator circuit could be used instead to detect the resonant frequency of the quartz crystal resonator 1.

As illustrated in FIG. 4, a coating 23 is provided on a surface (a main surface) of the quartz crystal wafer 3. As discussed below, various different materials may be used for the coating, for example SiO₂, or Al₂O₃, or TiN, or Cu, or W, or Si, or Si₃N₄, or TaN, or Co, or SiOₓ, or W doped C, or Co, or SnOₓ, or C, or SiCₓNᵥ. The coating 23 is a layer of the material on the surface of the quartz crystal wafer 3.

The coating 23 may have a thickness greater than, or equal, to 0.5 μm, for example. The coating may have a thickness less than or equal to 3 μm, for example.

The coating 23 may cover all or part of a main surface of the quartz crystal wafer 3. In this embodiment, the coating 23 is formed only on the main surface of the quartz crystal wafer 3.

In this embodiment, the first electrode 5 is formed on the top surface of the quartz crystal wafer 3 so as to cover only part of the top surface of the quartz crystal wafer 3, and the coating 23 is formed on another part of the top surface of the quartz crystal wafer 3 so as to cover another part of the top surface of the quartz crystal wafer 3. In other words, the first electrode 5 and the coating 23 are provided on different parts of the top surface of the quartz crystal wafer 3. This is not illustrated in FIG. 4 for simplicity. As illustrated in FIG. 4, the quartz crystal resonator 1 is held and/or supported by a holder 25. In particular, the holder 25 holds the quartz crystal resonator 1 so that the coating 23 provided on the surface of the quartz crystal wafer 3 is exposed. Specifically, the coating 23 is on a first main surface of the quartz crystal wafer 3 and the holder 25 holds the quartz crystal resonator 1 from a second main surface of the quartz crystal wafer 3.

In particular, the coating 23 is formed on a top surface of the quartz crystal wafer 3 and a bottom surface of the quartz crystal wafer 3 is received in the holder 25, so that the coating 23 is exposed and/or accessible.

The holder 25 is positioned in the opening 19 in the side surface of the tube 15, so that the coating 23 is exposed to liquid flowing along the tube 15. Therefore, when liquid flows along the tube 15, the liquid comes into contact with the coating 23 and flows over the coating 23.

In particular, the holder 25, and therefore the quartz crystal resonator 1 held by the holder 25, is received in the opening 19 in the side surface of the tube 15 with the coating 23 arranged to face an inside of the tube 15.

Therefore, when a liquid that is configured to etch a material of the coating 23 flows along the tube 15, the liquid comes into contact with the coating 23 and flows over the coating 23 so that the coating 23 is etched by the liquid.

The apparatus 11 illustrated in FIG. 4 can be used to investigate or monitor etching of the coating 23 when a liquid that is configured to etch the coating 23 flows in the tube 15. For example, the liquid may be hydrofluoric acid, or another etching liquid or chemical such as H₂O₂, for example

In particular, the quartz crystal microbalance 2 can be used to measure a decrease in mass per unit area of the coating 23 on the surface of the quartz crystal wafer 3 due to the etching, by measuring a change in oscillation frequency of the quartz crystal resonator 1 (or quartz crystal wafer 3) caused by the change in the mass per unit area of the coating 23 due to the etching. Specifically, as discussed above, the resonant frequency of the quartz crystal resonator 1 depends on the mass per unit area at the surface of the quartz crystal resonator 1. Therefore, a change in the mass per unit area at the surface of the quartz crystal resonator 1 will cause a shift (change) in the resonant frequency of the quartz crystal resonator 1. Therefore, by measuring the shift in the resonant frequency of the quartz crystal resonator 1, the change in the mass per unit area at the surface of the quartz crystal resonator 1 can be determined, for example calculated.

In particular, a decrease in the mass per unit area of the coating 23 may cause an increase in the resonant frequency of the quartz crystal resonator 1.

The quartz crystal microbalance 2 may have a sensitivity to changes in the mass per unit area of the order of 1 ng/cm². Typically, this corresponds to a change in thickness of less than or equal to 0.01 nm (0.1 Å) of the coating. For example, to achieve a 0.1 nm (1 Å) change in thickness of SiO₂ a reduction in the mass per unit area of 27 ng/cm² is required. To achieve a 0.1 nm (1 Å) change in thickness of Al₂O₃ a reduction in the mass per unit area of 40 ng/cm² is required. To achieve a 0.1 nm (1 Å) change in thickness of TiN a reduction in the mass per unit area of 54 ng/cm² is required.

The thickness of the coating 23 may be less than or equal to 3 μm. Such a thickness of the coating 23 may not significantly impact the sensitivity of the quartz crystal microbalance 2.

Assuming a typical etching cycle removes approximately 10 nm (100 Å) of the coating 23, this means that a 3 μm thickness coating 23 could be used to monitor approximately 300 etching cycles.

The apparatus may comprise one or more heaters or coolers for controlling a temperature of the quartz crystal wafer 3 and/or the flow cell 13 and/or the liquid in the flow cell 13. In addition, the apparatus may comprise one or more temperature sensors for sensing a temperature of the quartz crystal wafer 3 and/or the flow cell 13 and/or the liquid in the flow cell 13. The apparatus may further comprise a controller configured to control the one or more heaters or coolers based on an output of the one or more temperature sensors. In particular, the controller may be configured to control the one or more heaters or coolers to maintain a constant temperature, or substantially constant temperature, of the quartz crystal wafer 3 and/or the flow cell 13 and/or the liquid in the flow cell 13.

The resonant frequency of the quartz crystal resonator may be detected with the flow cell and an outlet of the flow cell at a predetermined or fixed height, so as to prevent pressure variations due to changes in height affecting the detection of the resonant frequency.

The quartz crystal wafer 3 may be configured to have a fundamental resonant frequency of approximately 5 MHz, or of the order of 5 MHz, for example.

The quartz crystal wafer 3 may have a diameter of approximately 25 mm, or of the order of 25 mm, or 25 mm, for example. Alternatively, the quartz crystal wafer may have a diameter of approximately 14 mm, or of the order of 14 mm, or 14 mm, for example.

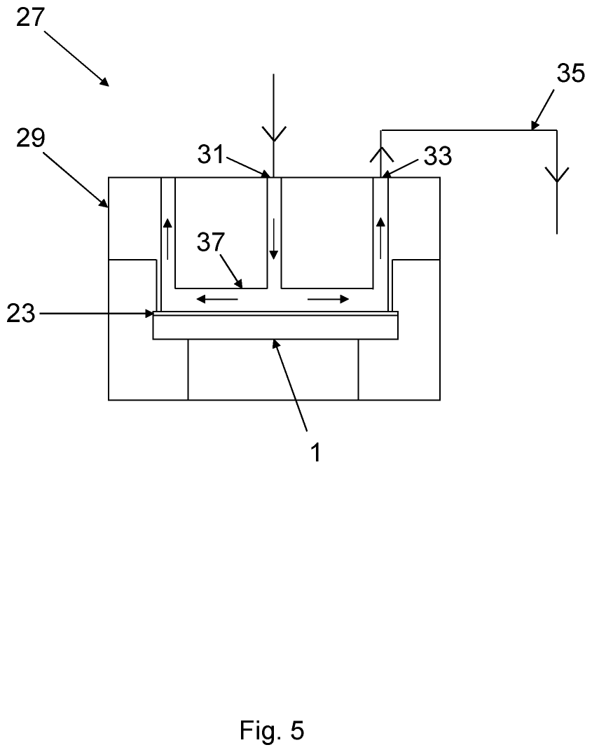

FIG. 5 is a schematic illustration of an apparatus according to a second embodiment of the present invention. As illustrated in FIG. 5, the apparatus 27 comprises a flow cell 29 which has a different configuration to the flow cell 13 illustrated in FIG. 4.

As illustrated in FIG. 5, the flow cell 29 comprises an inlet 31 for connecting the flow cell 29 to a supply of liquid so that the liquid can enter the flow cell 29 via the inlet 31. The flow cell 29 further comprises an outlet 33 for connecting the flow cell 29 to an external flow path 35 (for example a tube) so that the liquid can exit the flow cell 29 via the outlet 33. The outlet may be connected directly or indirectly to the supply of liquid so that the liquid exiting the flow cell 29 is recirculated and reused.

Furthermore, the flow cell 29 comprises a flow chamber 37 or flow path that is connected to the inlet 31 and the outlet 33 so that the liquid can flow from the inlet 31 to the outlet 33 through the flow chamber 37. The flow chamber 37 is arranged to bring the liquid into contact with a coating 23 on a quartz crystal wafer 3 of a quartz crystal resonator 1 of a quartz crystal microbalance, and to flow the liquid over the coating 23.

In particular, as illustrated in FIG. 5, a quartz crystal resonator 1 of a quartz crystal microbalance is received or housed in the flow cell 29. For example, the flow cell 29 may comprise a space or cavity in which the quartz crystal wafer 3 can be received. The flow cell 29 may comprise one or more holes or openings through which wires can be passed to connect to the electrodes of the quartz crystal resonator 1.

The quartz crystal resonator 1, the coating 23 and the quartz crystal microbalance in this embodiment may have any of the features of the quartz crystal resonator 1, the coating 23 and the quartz crystal microbalance 2 of the first embodiment described above or illustrated in any of FIGS. 1 to 4, unless incompatible. Although not illustrated, the quartz crystal resonator 1 includes the electrodes 5 and 7 on the quartz crystal wafer 3 as illustrated in FIG. 1. In addition, the quartz crystal microbalance includes the controller 4 and crystal oscillator electronics 6 as illustrated in FIG. 2, and as described above. The quartz crystal microbalance may further comprise the oscillator circuit illustrated in FIG. 3 and described above for detecting the resonant frequency of the quartz crystal resonator 1. Of course, other types of oscillator circuit could be used instead to detect the resonant frequency of the quartz crystal resonator 1. Description of these features is therefore not repeated here for conciseness.

The flow chamber 37 of the flow cell is arranged so that the flow chamber 37, or part of the flow chamber 37, is adjacent to the coating 23, so that liquid flowing through the flow chamber 37 contacts the coating 23 and flows over the coating 23.

The flow chamber 37, or the part of the flow chamber 37, has an open side where it faces the coating 23, so that liquid flowing through the flow chamber can contact the coating 23.

The flow chamber 37, or part of the flow chamber 37, may be disc shaped, so that the liquid is brought into contact with the coating 23 in a circular area or region of a top surface of the coating 23.

The flow cell 29 is made of, or comprises, a material that is not etched by the etching liquid. For example, the flow cell may be made of, or may comprise, polytetrafluoroethylene (PTFE). In general, the flow cell is made of, or comprises, a chemically inert material. In particular, the flow cell 29 comprises a material that is inert with respect to, and/or that is compatible with, with the liquid supplied to the flow cell, for example an etching liquid or etching chemical.

A volume of the flow chamber 37 (for example from an inlet of the flow chamber 37 to an outlet of the flow chamber 37) may be less than or equal 10 mL. The volume may be greater than or equal to 0.1 mL. The volume may be greater than or equal to 0.1 mL and less than or equal to 10 mL. In a specific embodiment the volume may be greater than or equal to 1 mL and less than or equal to 2 mL, for example greater than or equal to 1.0 mL and less than or equal to 2.0 mL, for example approximately 1 mL.

A volume of a region of the flow chamber 37 that is opposite (for example directly opposite) to an area of the quartz crystal resonator that is in contact with the liquid may be less than or equal to 2 mL, for example less than or equal to 2.0 mL. The volume may be greater than or equal to 0.05 mL. The volume may be greater than or equal to 0.05 mL and less than or equal to 2 mL or 2.0 mL, for example approximately 0.15 mL.

A volume of a region of the flow chamber 37 defined by an area of the quartz crystal resonator that is in contact with the liquid multiplied by a distance between the quartz crystal resonator and an opposing surface of the flow chamber 37 may be less than or equal to 2 mL, for example less than or equal to 2.0 mL. The volume may be greater than or equal to 0.05 mL. The volume may be greater than or equal to 0.05 mL and less than or equal to 2 mL or 2.0 mL, for example approximately 0.15 mL.

The distance between the area of the quartz crystal resonator in contact with the liquid and the opposing surface of the flow chamber may be greater than or equal to 0.2 mm and less than or equal to 5 mm, for example approximately 2 mm.

The area of the quartz crystal resonator in contact with the liquid may be greater than or equal to 0.1 cm² and less than or equal to 10 cm², for example approximately 0.5 cm².

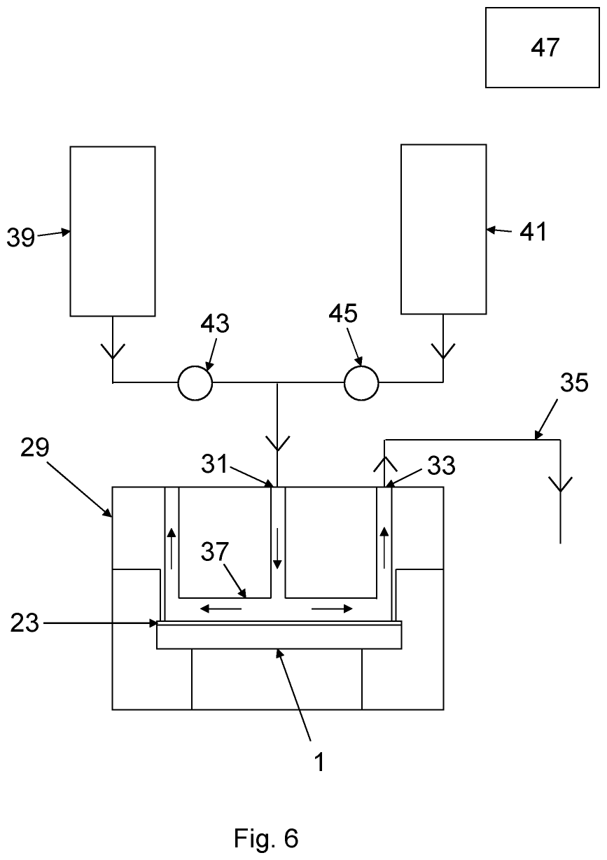

FIG. 6 shows the flow cell 29 of FIG. 5 connected to a supply of liquid. In particular, a first liquid container or tank (first liquid source) 39 containing a first liquid and a second liquid container or tank (second liquid source) 41 containing a second liquid are both connected to the inlet 31 of the flow chamber 29 by respective flow paths. A first valve 43 is positioned in the flow path connecting the first liquid container 39 to the inlet 31, and a second valve 45 is positioned in the flow path connecting the second liquid container 41 to the inlet 31.

The first valve 43 can be opened to supply the first liquid to the inlet 31 of the flow cell 29 or closed to prevent supply of the first liquid to the inlet 31. Similarly, the second valve 45 can be opened to supply the second liquid to the inlet 31 of the flow cell 29 or closed to prevent supply of the second liquid to the inlet 31.

In this embodiment the first liquid is a cleaning or rinse liquid, such as deionised water. In addition, the second liquid is an etching liquid or chemical such as hydrofluoric acid. Of course, other etching chemicals may be used instead, such as H₂O₂, for example.

In operation of the apparatus, the first valve 43 can be set to open and the second valve 45 set to closed so that the cleaning or rinse liquid is supplied to the flow cell 29. The cleaning or rinse liquid therefore flows through the flow chamber 37 across the coating 23 and cleans or rinses the coating 23. This may be referred to as a first cleaning or rinse step.

Subsequently, the first valve 43 can be set to closed and the second valve 45 set to open so that the etching liquid is supplied to the flow cell 29. The etching liquid therefore flows through the flow chamber 37 across the coating 23 and etches the coating, thereby changing a mass per unit area of the coating 23 and therefore a resonant frequency of the quartz crystal resonator 1. This may be referred to as an etching step.

Subsequently, the first valve 43 can be set to open and the second valve 45 set to closed so that the cleaning or rinse liquid is supplied to the flow cell 29. The cleaning or rinse liquid therefore flows through the flow chamber 37 across the coating 23 and cleans or rinses the coating 23. This may be referred to as a second cleaning or rinse step.

The apparatus may comprise a controller 47 that is configured to control opening and closing of the first valve 43 and second valve 45, to control supply of the first and second liquids to the flow cell 29.

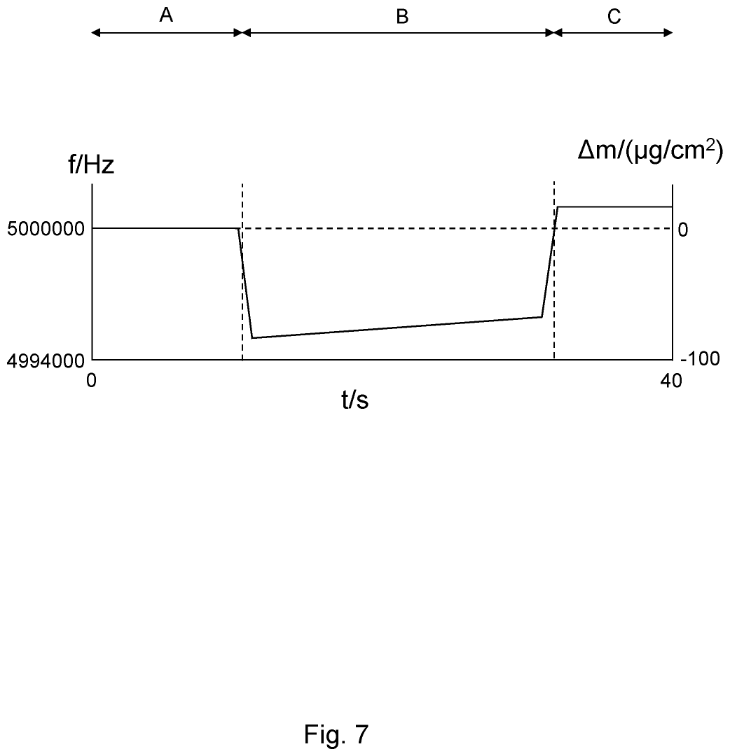

FIG. 7 is an example of measurement data obtained during the operation of the apparatus described above.

Regions A and C in FIG. 7 correspond to the first cleaning or rinse step and the second cleaning or rinse step respectively. Region B in FIG. 7 corresponds to the etching step.

As shown in FIG. 7, during the first cleaning or rinse step, in which only the cleaning or rinse liquid is supplied to the flow cell 29, a resonant frequency of the quartz crystal resonator 1 is determined to be 5 MHZ. This resonant frequency is determined by the properties of the quartz crystal wafer 3 and by the properties of the coating 23 (i.e. the mass per unit area of the coating 23).

As shown in FIG. 7, during the subsequent etching step, the resonant frequency initially decreases when the cleaning or rinse liquid in the flow cell 29 is replaced with the etching liquid, due to the different densities and viscosities of the cleaning or rinse fluid and the etching liquid.

While the etching liquid is supplied to the flow cell 29, the etching liquid etches the coating 23, removing some of the coating 23 and therefore reducing a mass per unit area of the coating 23. This gradual reduction in the mass per unit area of the coating 23 causes a gradual increase in the resonant frequency of the quartz crystal resonator 1, as illustrated in FIG. 7.

As shown in FIG. 7, during the subsequent second cleaning or rinse step the resonant frequency initially increases when the etching liquid in the flow cell 29 is replaced with the cleaning or rinse liquid, due to the different densities and viscosities of the cleaning or rinse liquid and the etching liquid. Subsequently, as illustrated in FIG. 5, the resonant frequency settles on a stable value.

As illustrated in FIG. 5, the stable value of the resonant frequency in the second cleaning or rinse step is higher than the stable value of the resonant frequency in the first cleaning or rinse step, because the coating 23 has been etched between the first cleaning or rinse step and the second cleaning or rinse step so that a mass per unit area of the coating 23 is less in the second cleaning or rinse step than in the first cleaning or rinse step.

By measuring the shift or change in the resonant frequency between the first cleaning or rinse step and the second cleaning or rinse step, a change in the mass per unit area of the coating 23 due to the etching can be determined or calculated. Therefore, an amount of etching of the coating 23 by the etching liquid can be determined, and the etching can therefore be monitored. For example, an etching rate of the coating 23 by the liquid cam be calculated.

As an alternative, instead of comparing the resonant frequency of the quartz crystal wafer 3 between the first cleaning or rinse step and the second cleaning or rinse step, a resonant frequency of the quartz crystal wafer 3 at a start of the etching step while the etching liquid is being supplied to the flow cell 29 can be compared to a resonant frequency of the quartz crystal wafer 3 at an end of the etching step while the etching liquid is being supplied to the flow cell 29. In other words, a shift in the resonant frequency of the quartz crystal wafer can be determined between a resonant frequency near the start of the region B in FIG. 5 and a resonant frequency near the end of the region B in FIG. 5.

In practice, there may be a larger period of time required than that illustrated in FIG. 5 for the measured resonant frequency to settle on a steady value after transitioning from the cleaning or rinse liquid to the etching liquid and after transitioning from the etching liquid to the cleaning or rinse liquid. For example, a stabilisation time of a few minutes may be required.

As an alternative, a first resonant frequency of the quartz crystal resonator 1 may be measured while the quartz crystal resonator 1 is dry. For example, an initial resonant frequency of the quartz crystal resonator 1 may be measured in a dry state, i.e. with no liquid applied to the coating 23. An etching liquid may then be applied to the coating 23 on the quartz crystal wafer 3 to etch the coating 23. Subsequently, the quartz crystal resonator 1 may be dried and a second resonant frequency of the quartz crystal resonator 1 may be measured while the quartz crystal resonator 1 is dry. In addition, a cleaning or rinsing liquid may be applied to the coating 23 after and/or before the etching liquid is applied to the coating 23.

The quartz crystal resonator 1 and/or the coating 23 may be dried by supplying a gas such as N2 to the quartz crystal resonator 1 and/or the coating 23 to dry the coating. For example, the gas may be provided using one of the liquid supply paths illustrated in FIG. 6, or by an additional gas supply path that is connected to a gas container or tank. The apparatus may comprise a valve for controlling supply of the gas to the quartz crystal resonator 1 and/or coating 23.

Of course, in other embodiments of the present invention a different configuration of flow cell may be used instead of the flow cells 13 and 29 of the first and second embodiments.

The apparatus of the present invention can be used or applied for monitoring etching of a material on a surface of a wafer during processing of the wafer, for example during semiconductor device fabrication.

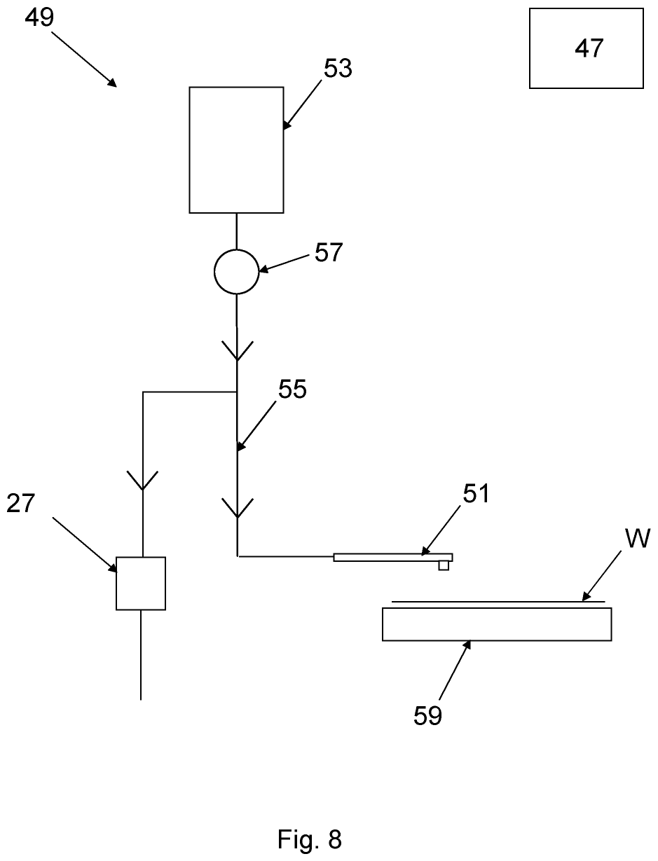

FIG. 8 is a schematic illustration of an apparatus according to an embodiment of the present invention.

As illustrated in FIG. 8, a wafer processing apparatus 49 according to this embodiment comprises a liquid dispenser 51 for dispensing a liquid onto a surface of a wafer W. The wafer processing apparatus 49 is for etching a material on a surface of the wafer W by dispensing an etching liquid onto the surface of the wafer W. The etching liquid is configured to etch the material of the surface of the wafer W.

As illustrated in FIG. 8, the wafer processing apparatus 49 comprises a liquid source 53 and a liquid supply 55 for supplying a liquid from the liquid source 53 to the liquid dispenser 51.

For example, the liquid source 53 may be a container or tank of the liquid. Alternatively, the liquid source 53 may be a flow path, tube or passageway that supplies the liquid to the liquid supply 55 of the wafer processing apparatus 49.

The liquid supply 55 comprises a flow path, for example a tube or passageway, that is configured to supply the liquid from the liquid source 53 to the liquid dispenser 51.

The liquid source 53 may be external to the wafer processing apparatus 49, and therefore not part of the wafer processing apparatus 49. Alternatively, the wafer processing apparatus 49 may comprise the liquid source 53.

The liquid supply 55 comprises a valve 57 for controlling the supply of liquid from the liquid source 53 to the liquid dispenser 51 through the liquid supply 55. In particular, the valve 57 can be opened so that liquid is supplied from the liquid source 53 to the liquid dispenser 51 or closed so that liquid is not supplied from the liquid source 53 to the liquid dispenser 51.

The operation of the valve 57 may be controlled by a controller 47 of the wafer processing apparatus 49.

The controller 47 may control the apparatus 49 to perform an etching cycle in which the valve 57 is opened for a predetermined period of time so that an etching liquid is supplied from the liquid source 53 to the liquid dispenser 51 and dispensed onto the surface of the wafer W for the predetermined period of time. The etching liquid is configured to etch a material on the surface of the wafer.

In addition, the wafer processing apparatus 49 further comprises the apparatus 27 of the second embodiment described above. Of course, the apparatus 11 of the first embodiment described above could be used instead of the apparatus 27 of the second embodiment, or a different configuration of the flow cell could be used to that used in either the first or second embodiments.

As illustrated in FIG. 8, the apparatus 27 of the second embodiment is connected to the liquid supply 55. In particular, a flow path is branched off the liquid supply 55 and connected to the apparatus 27. In particular, the inlet 31 of the flow cell 29 is connected to the liquid supply 55. In FIG. 8 the liquid is simultaneously supplied to the apparatus 27 and the liquid dispenser 51 when the valve 57 is open. However, in other embodiments one or more additional valves may be provided, and/or the valve 57 may be moved, so that supply of liquid to the apparatus 27 can be controlled independently of the supply of liquid to the liquid dispenser 51.

In the embodiment of FIG. 8, while the etching liquid is supplied from the liquid source 53 to the liquid dispenser 51 and dispensed onto the wafer, the etching liquid is simultaneously supplied from the liquid supply 53 to the flow chamber 37 of the flow cell 29 where it is flowed across the coating 23 of the quartz crystal wafer 3 and etches the coating 23.

Of course, the apparatus 27 could alternatively be connected directly to the liquid source 53, and a further valve could be provided for controlling the supply of the liquid from the liquid source 53 to the apparatus 27.

A material of the coating 23 is selected to be the same as a material of the surface of the wafer W that is being etched. Therefore, the coating 23 is etched simultaneously to the etching of the material on the surface of the wafer W when the liquid is supplied simultaneously to the wafer W and the coating 23.

In particular, since a material of the coating 23 is the same as a material of the surface of the wafer W, an amount of etching of the coating 23 by the liquid may be the same as, or related to, or correspond to, an amount of etching of the material of the surface of the wafer W, when they are both exposed to the liquid in the same or corresponding manner. Therefore, by monitoring the etching of the coating 23 as described above it may be possible to indirectly monitor the etching of the material on the surface of the wafer W.

The wafer processing apparatus 49 (for example the controller 47) may be configured to determine, or calculate, or estimate, information indicative of an amount of etching of the material of the surface of the wafer W from a shift in the resonant frequency of the quartz crystal resonator of the apparatus 27.

The wafer processing apparatus 49 (for example the controller 47) may be configured to monitor etching of the material of the surface of the wafer W based on, or from, a shift in the resonant frequency of the quartz crystal resonator of the apparatus 27.

The wafer processing apparatus 49 (for example the controller 47) may be configured to determine, or calculate, or estimate, based on the shift in the resonant frequency of the quartz crystal resonator of the apparatus 27: an etch rate of the material of the surface of the wafer; or a decrease in the mass per unit area of the material of the surface of the wafer; or a decrease in mass of the material of the surface of the wafer; or a decrease in thickness of the material of the surface of the wafer.

The wafer processing apparatus (for example the controller 47) may be configured to control an operation of the liquid dispenser 51 or of the wafer processing apparatus based on a shift in the resonant frequency of the quartz crystal resonator.

For example, when a desired or predetermined amount of etching of the coating 23 is determined, the wafer processing apparatus 49 (for example the controller 47) may be configured to stop dispensing of the liquid by the liquid dispenser 51.

The wafer processing apparatus 49 (for example the controller 47) may be configured to determine whether or not a desired or predetermined shift in the resonant frequency of the quartz crystal resonator has occurred and to stop dispensing of the liquid onto the surface of the wafer when it is determined that the desired or predetermined shift in the resonant frequency of the quartz crystal resonator has occurred.

The liquid dispenser 51 comprises a nozzle for dispensing the liquid onto the surface of the wafer. The nozzle is positioned or located or provided on an arm of the wafer processing apparatus 49. The arm is pivotably mounted so that a position of the nozzle relative to the wafer W can be changed.

The wafer processing apparatus comprises a support or chuck 59 for supporting or holding the wafer. The support or chuck 59 may be rotatable.

As shown in FIG. 8, the support or chuck 59 supports the wafer W from beneath while the liquid is dispensed onto the wafer from above, i.e. onto a top surface of the wafer.

Although FIG. 8 shows only a single liquid source 53, a plurality of liquid sources 53 may be provided. For example, similarly to FIG. 6 the apparatus 49 may comprise a first liquid source 53 and a second liquid source 53, with respective valves, for supplying a first liquid and a second liquid respectively to the liquid supply 55. Alternatively, a separate liquid supply may be provided for each of the liquid sources to supply the respective liquid to the liquid dispenser 51 and the apparatus 27.

The first liquid may be a cleaning or rinse liquid and the second liquid may be an etching liquid, similarly to the arrangement described with reference to FIG. 6.

The apparatus 49 may be controlled (for example by the controller 47) to firstly supply the cleaning or rinse liquid simultaneously to both the liquid dispenser 51 and the apparatus 27. Subsequently, the apparatus 49 may be controlled to secondly supply the etching liquid simultaneously to both the liquid dispenser 51 and the apparatus 27. Subsequently, the apparatus 49 may be controlled to thirdly supply the cleaning or rinse liquid simultaneously to the liquid dispenser 51 and the apparatus 27. The description above regarding the apparatus 27 in each of these steps equally applies to this embodiment.

A single liquid supply 55 may be connected to each of the plurality of different liquid sources for supplying the different liquids to the liquid dispenser 51. Alternatively, there may be a plurality of liquid supplies for supplying the liquids from the liquid sources to the liquid dispenser 51.

There may be more than one liquid dispenser 51. For example, a different liquid dispenser 51 may be used for each different liquid supplied from each liquid source.

In some embodiments, the apparatus may be controlled to supply the liquid to the apparatus 27 without supplying the liquid to the liquid dispenser 51. Based on a shift in the resonant frequency of the quartz crystal resonator, the apparatus may determine an etching rate or an amount of etching of the coating by the liquid. The apparatus may then use this information to control or modify subsequently dispensing the liquid onto the surface of the wafer W from the liquid dispenser 51. For example, the apparatus may control an amount of the liquid that is dispensed onto the surface of the wafer W, and/or a duration over which the liquid is dispensed onto the surface of the wafer W based on the determined etching rate or amount of etching.

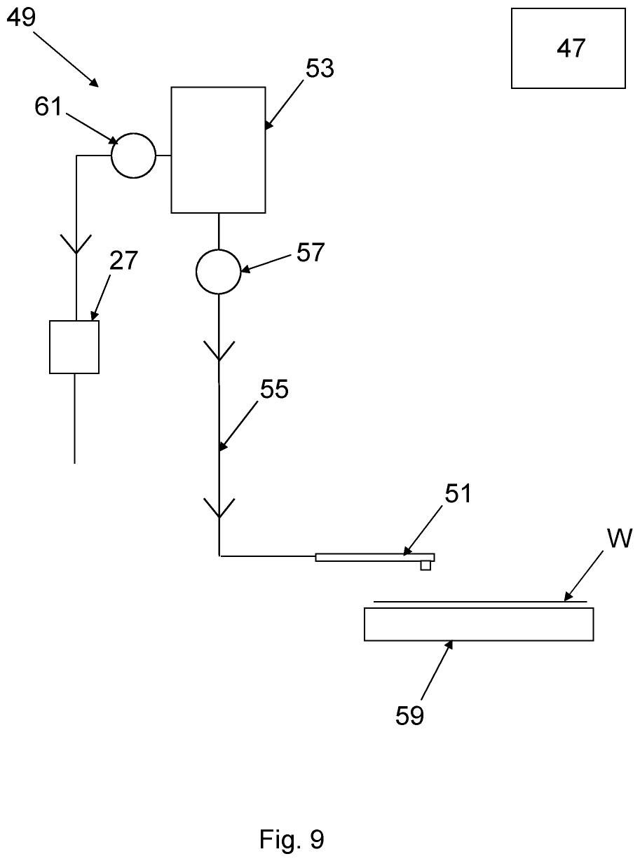

FIG. 9 shows a modified version of the apparatus of FIG. 8 in which the apparatus 27 is directly connected to the liquid source 53 by a flow path. A valve 61 is provided in the flow path for controlling the supply of liquid from the liquid source 53 to the apparatus. Although not illustrated, an outlet of the apparatus may be connected directly or indirectly to the liquid source 53, so that the liquid is recirculated between the liquid source 53 and the device 27.

The other features of this apparatus and its operation may otherwise be the same as described above with relation to FIG. 8.

In this embodiment, the valve 61 may be controlled to supply the liquid to the apparatus 27 in order to determine an etching amount or etch rate of the coating by the liquid. This information may then be used to control or modify dispensing the liquid onto the surface of the wafer W from the liquid dispenser 51. For example, the apparatus may control an amount of the liquid that is dispensed onto the surface of the wafer W, and/or a duration over which the liquid is dispensed onto the surface of the wafer W.

Alternatively, in this embodiment the valves 61 and 57 may be controlled to simultaneously supply the liquid to the liquid dispenser so it is dispensed on the wafer and to the apparatus 27, for example as described above.

In any of the embodiments described above, a flow rate controller or limiter may be provided at an input to the flow cell, or upstream of the input, to control and/or limit a flow rate of the liquid through the flow cell. For example, the flow rate may be limited to be less than, or equal to, 10 mL/min, for example less than, or equal to 5 mL/min. This may prevent or reduce leakage from the flow cell and/or damage to the flow cell, coating or quartz crystal.

The apparatus of the present invention may allow or enable comparison or matching of different chemical supplies (for example for different wafer processing apparatus or mixing systems on the same wafer processing apparatus), for example.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1. An apparatus comprising:
a quartz crystal microbalance comprising a quartz crystal resonator having a coating; and
a flow cell arranged to flow a liquid over the coating.

2. The apparatus according to claim 1, wherein the coating comprises one or more of SiO₂, or Al₂O₃, or TiN, or Cu, or W, or Si, or Si₃N₄, or TaN, or Co, or SiOₓ, or W doped C, or Co, or SnOₓ, or C, or SiCₓNᵥ.

3. The apparatus according to claim 1, wherein the coating has a thickness that is:
greater than, or equal to, 0.01 μm; and/or
greater than, or equal to, 0.1 μm; and/or
greater than, or equal to, 0.5 μm; and/or
greater than, or equal to, 1 μm; and/or
less than, or equal to, 5 μm; and/or
less than, or equal to, 10 μm.

4. The apparatus according to claim 1, wherein the apparatus is configured to detect a resonant frequency of the quartz crystal resonator.

5. The apparatus according to claim 1, wherein the apparatus is configured to determine a shift in a resonant frequency of the quartz crystal resonator.

6. The apparatus according to claim 5, wherein the apparatus is configured to determine information indicative of an amount of etching of the coating by the liquid from the shift in the resonant frequency of the quartz crystal resonator.

7. The apparatus according to claim 5, wherein the apparatus is configured to monitor etching of the coating by the liquid based on the shift in the resonant frequency of the quartz crystal resonator.

8. The apparatus according to claim 5, wherein the apparatus is configured to determine, based on the shift in the resonant frequency of the quartz crystal resonator:
an etch rate of the coating; or
a decrease in the mass per unit area of the coating; or
a decrease in the mass of the coating; or
a decrease in the thickness of the coating.

9. The apparatus according to claim 1, wherein the apparatus comprises a liquid source connected to the flow cell and configured to supply a liquid to the flow cell.

10. The apparatus according to claim 9, wherein the liquid is configured to etch the coating.

11. The apparatus according to claim 1, wherein the apparatus comprises:
a first liquid source connected to the flow cell for supplying a first liquid to the flow cell;
a second liquid source connected to the flow cell for supplying a second liquid to the flow cell; and
one or more valves for controlling supply of the first liquid to the flow cell and supply of the second liquid to the flow cell.

12. The apparatus according to claim 11, wherein:
the first liquid is configured to etch the coating, and/or
the second liquid comprises a cleaning or rinse liquid.

13. A wafer processing apparatus comprising:
a liquid dispenser for dispensing a liquid onto a surface of a wafer;
a liquid supply for supplying a liquid from a liquid source to the liquid dispenser; and
the apparatus according to claim 1, wherein the flow cell is connected to the liquid source or the liquid supply.

14. The wafer processing apparatus according to claim 13, wherein the flow cell is connected to the liquid source via a recirculation loop between the liquid source and the flow cell.

15. The wafer processing apparatus according to claim 13, wherein the flow cell is connected to the liquid supply in series with the liquid dispenser, or in parallel with the liquid dispenser.

16. The wafer processing apparatus according to claim 13, wherein the wafer processing apparatus is configured to:
dispense the liquid onto the surface of the wafer from the liquid dispenser; and
simultaneously supply the liquid to the flow cell.

17. The wafer processing apparatus according to claim 13, wherein the wafer processing apparatus is configured to determine information indicative of an amount of etching of a material of the surface of the wafer from a shift in the resonant frequency of the quartz crystal resonator.

18. The wafer processing apparatus according to claim 13, wherein the wafer processing apparatus is configured to monitor etching of a material of the surface of the wafer based on a shift in the resonant frequency of the quartz crystal resonator.

19. The wafer processing apparatus according to claim 13, wherein the wafer processing apparatus is configured to determine, based on a shift in the resonant frequency of the quartz crystal resonator:
an etch rate of the material of the surface of the wafer; or
a decrease in the mass per unit area of the material of the surface of the wafer; or
a decrease in mass of the material of the surface of the wafer; or
a decrease in thickness of the material of the surface of the wafer.

20. The wafer processing apparatus according to claim 13, wherein the wafer processing apparatus is configured to control an operation of the wafer processing apparatus based on a shift in the resonant frequency of the quartz crystal resonator.

21. A method comprising:
flowing a liquid over a coating on a quartz crystal resonator of a quartz crystal microbalance using a flow cell.

22. The method of claim 21, wherein the liquid is configured to etch the coating.

23. The method according to claim 21, wherein the coating comprises one or more of SiO₂, or Al₂O₃, or TiN, or Cu, or W, or Si, or Si₃N₄, or TaN, or Co, or SiOₓ, or W doped C, or Co, or SnOₓ, or C, or SiCₓNᵥ.

24. The method according to claim 21, wherein the liquid comprises one or more of hydrofluoric acid, or H₂O₂, or HNO₃, or HNO₃ and HF, or DIO₃, or NH₄OH, or HCL.

25. The method according to claim 21, wherein the method comprises detecting a resonant frequency of the quartz crystal resonator.

26. The method according to claim 21, wherein the method comprises determining a shift in a resonant frequency of the quartz crystal resonator.

27. The method according to claim 26, wherein the method comprises determining information indicative of an amount of etching of the coating by the liquid from the shift in the resonant frequency of the quartz crystal resonator.

28. The method according to claim 26, wherein the method comprises monitoring etching of the coating by the liquid based on the shift in the resonant frequency of the quartz crystal resonator.

29. The method according to claim 26, wherein the method comprises determining, based on the shift in the resonant frequency of the quartz crystal resonator:
an etch rate of the coating; or
a decrease in the mass per unit area of the coating; or
a decrease in mass of the coating; or
a decrease in thickness of the coating.

30. The method according to claim 21, wherein the method comprises simultaneously dispensing the liquid onto a surface of a wafer, wherein the surface of the wafer comprises a same material as a material of the coating.

31. The method according to claim 30, wherein the method comprises determining information indicative of an amount of etching of the material of the surface of the wafer from a shift in the resonant frequency of the quartz crystal resonator.

32. The method according to claim 30, wherein the method comprises monitoring etching of the material of the surface of the wafer from a shift in the resonant frequency of the quartz crystal resonator.

33. The method according to claim 30, wherein the method comprises determining, based on a shift in the resonant frequency of the quartz crystal resonator:
an etch rate of the material of the surface of the wafer; or
a decrease in the mass per unit area of the material of the surface of the wafer; or
a decrease in mass of the material of the surface of the wafer; or
a decrease in thickness of the material of the surface of the wafer.

34. The method according to claim 30, wherein the method comprises controlling dispensing the liquid onto the surface of the wafer based on a shift in the resonant frequency of the quartz crystal resonator.

35. The method according to claim 21, wherein the method comprises:
flowing a cleaning or rinse liquid over the coating on the quartz crystal resonator;
subsequently flowing a liquid that is configured to etch the coating over the coating on the quartz crystal resonator; and
subsequently flowing a cleaning or rinse liquid over the coating on the quartz crystal resonator.

36. The method according to claim 35, wherein the method comprises:
detecting a first resonant frequency of the quartz crystal resonator while flowing the cleaning or rinse liquid over the coating on the quartz crystal resonator before the liquid that is configured to etch the coating;
detecting a second resonant frequency of the quartz crystal resonator while flowing the cleaning or rinse liquid over the coating on the quartz crystal resonator after the liquid that is configured to etch the coating; and
determining a shift in the resonant frequency of the quartz crystal resonator from the first resonant frequency and the second resonant frequency.
